(19) United States
(12) Patent Application Publication
(10) Pub. No.: US 2003/0183709 A1
(43) Pub. Date: Oct. 2, 2003

(54) Cheese breaker

(76) Inventor: Thomas J. Greenlaw, Little River, SC (US)

Correspondence Address: RATNERPRESTIA, P O BOX 980, VALLEY FORGE, PA, 19482-0980, US

(21) Appl. No.: 10/108,076

(22) Filed: Mar. 26, 2002

(51) Int. Cl. B02C 19/12

(52) U.S. Cl. 241/243

(57) ABSTRACT

Apparatus for separating cheese that has previously been shredded but matted together due to temperature, or settling from being in stacked containers. A central roller has tines projecting from an outer surface that mesh with opposing rows of fixed tines supported in a housing which contains the central roller. The tines can be arranged along the surface of the roller in straight or curved rows and the roller can be turned by hand or by motor.

### BACKGROUND OF THE INVENTION

The present invention pertains to separation of cheese and in particular to separation of cheese that has previously been shredded but has been matted together by temperature, or settling from stacking.

Cheese, especially mozzarella cheese is a common topping for the number one selling fast food, pizza. Cheese toppings that are used by the purveyors of cooked pizza are shredded prior to being used in the pizza baking process. A large number of cheese cutters are available and are known to the prior art.

Examples of prior art devices for initially shredding cheese are shown and described in U.S. Pat. Nos. 3,187,432, 3,618,211, 3,888,428, 3,980,235, 4,620,838, 5,983,769 and 5,702,061.

In a conventional pizza making operation the topping cheese, e.g., mozzarella cheese, is preshredded and stored in refrigerators either in, e.g., a tub, tray, plastic storage bags, etc. A common problem with storage of shredded cheese is that it will matte due to storage at low (refrigeration) temperatures or it will matte because of storage at refrigeration temperatures by settling due to stacking of bags or containers of the cheese. It is conventional to take the matted cheese and break it up by hand.

It is also been a common practice to try and reshred the cheese through a conventional shredding machine. However, reshredding the matted cheese causes a drastic change in the consistency of the cheese which results in the cheese melting differently than if it were used before the cheese became matted and was reshredded. The difference in the melting characteristics of the cheese topping will change the cooking process for the pizza and will affect the appearance and taste of the cooked pizza. There are suppliers that will provide pre-shredded cheese in bags but this is a more expensive item to the pizza shop owner. Furthermore, pre-shredded cheese in bags, if stored improperly will matte similar to block cheese that has been shredded by the pizza shop owner.

Therefore, there is a need for a device to rapidly and effectively separate matted pre-shredded cheese without changing the characteristics of the cheese.

### SUMMARY OF THE INVENTION

The present invention is a device for separating shredded cheese that has been matted together, i.e., by temperature, pressure, settling from being in stacked containers or the like comprising in combination; a housing having the shape of a rectangular prism, the housing having four sides with an open top and a bottom shelf, the bottom shelf adapted to be one of opened or pivoted away from one side of the housing, the shelf adapted to permit recirculation of the cheese and to permit removal of separated cheese, a generally cylindrical roller mounted in the housing for rotation about an axis located proximate the open bottom of the housing, the axis extending between opposite smaller faces of the prism, a plurality of tines embedded in and perpendicular to an outer surface of the roller, the tines arrayed in at least four rows, each of the rows parallel to and spaced apart from an adjacent row, each row extending along a substantial length of the outer surface of the roller, the tines in a row of tines spaced from each other by a distance of at least one half inch, and a plurality of fixed position tines mounted in two opposing rows on opposite larger faces of the housing adjacent the open bottom of the housing, the fixed position tines of a number and spacing to mesh with close tolerance spacing with the tines mounted on the cylinder as the cylinder is rotated.

The device of the present invention can include a cover for the open top of the housing.

A feature of the invention is an auxiliary stand in the shape of an open frame that is adapted to support the housing above a receptacle so that as the matted cheese is processed or separated it falls into a suitable container for application in the pizza making process by a user.

Another feature of the invention is the use of tines spaced in a curved array along the surface of the cylinder, the tines being in parallel rows of curved array.

The roller of the present invention can be rotated by hand or connected to a motor for motorized rotation.

### BRIEF DESCRIPTION OF THE DRAWING

FIG. 1 is a top plan view of an apparatus according to the invention.

FIG. 2 is a left side elevational view of the device of FIG. 1.

FIG. 3 is a left side elevational view of the device of FIG. 1 illustrating the movable bottom shelf in position to discharge the reshredded cheese.

FIG. 4 is a front elevational view of the device according to the invention illustrating a step in the use of the device.

FIG. 5 is a partial isometric view of the device of FIG. 3 showing the apparatus of the invention in a further stage during normal use.

FIG. 6 is a partial isometric view identical to FIG. 5 except for showing removal of the reshredded cheese from the device.

### DETAILED DESCRIPTION OF THE INVENTION

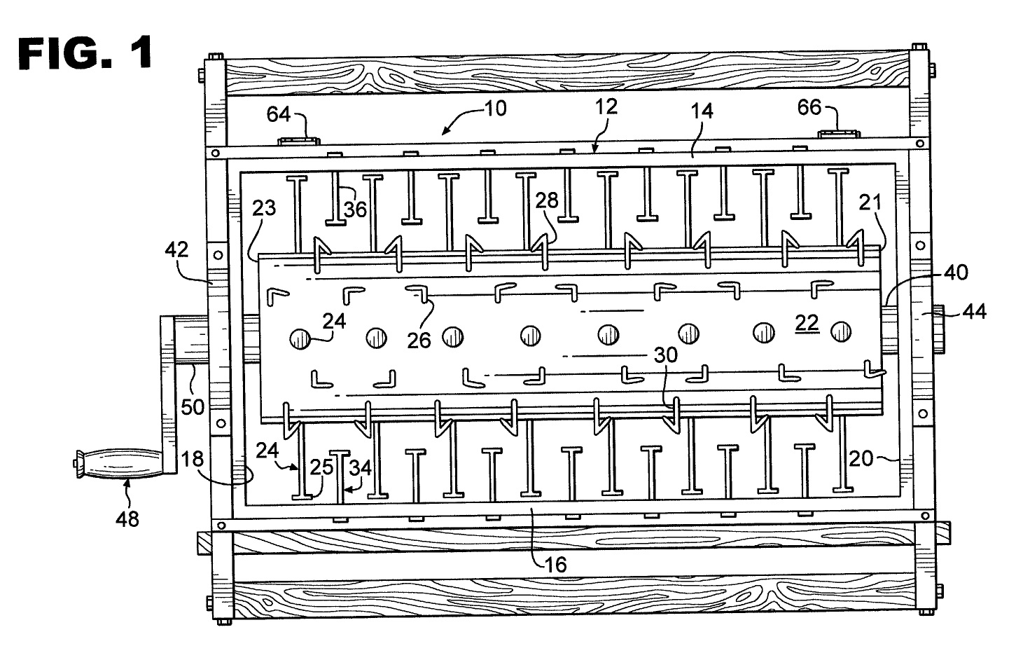

Referring to FIGS. 1, 2 and 3 the basic apparatus 10 of the invention includes a housing 12 which is in the shape of a regular or rectangular prism having two long faces 14, 16 and two shorter faces 18 and 20. Mounted for rotation within the housing 12 is a cylinder or roller 22. The cylinder or roller 22 has embedded in its outer surface equally spaced tines all of which are illustrated by tines numbered 24, 26, 28 and 30. The tines 24, 26, 28 and 30 can be in the shape of generally cylindrical pegs with or without heads. For example, pegs or tines 24 have generally cylindrical heads to provide more surface area to contact the agglomerated (matted) cheese when the device 10 is in use. Tines 26, 28, and 30 can be in the shape of a hook with the short end giving the hook an “L” shaped appearance as shown or with the short end curved. In either case the short end can be oriented to the side or parallel to the axis of the cylinder or roller 22. Tines 26, 28 and 30 can be different lengths. The tines 24, 26, 28 and 30 are shown in the position of rows spaced equally around the surface of the roller 22 along a straight line from adjacent edge 21 to adjacent edge 23 of the roller 22.

In one embodiment the tines 24, 26, 28, and 30 can be placed along parallel arcs of circles, the arcs drawn across the face or outer surface of roller 22. The tines should be equally spaced with a spacing approximately one half inch apart. It is also within the scope of the invention to have more than four rows of tines with intermediate rows being of a shorter length with or without a headed portion. As shown in FIG. 1 the rows of tines can be placed in generally parallel rows with the hooked tines facing in different directions. Each row can have a full set of tines or a tine at every other location aligned with the tines of an adjacent row. As stated before the drawing shows the tines in a form for illustration and understanding of the basis of the invention only.

Disposed on opposite larger faces 14, 16 of the housing 12 are rows of stationary tines 34, 36. The stationary tines 34, 36 are arrayed in two rows on opposite sides of the housing 12 in a spacing that is dictated by the spacing of the tines on the roller 22 so that the fixed or stationary tines 34, 36 will mesh with moveable tines 24, 26, 28, and 30 with a defined clearance as the roller 22 is turned. The stationary tines 34, 36 can have a headed portion with a cylindrical shank as shown in the drawings. Roller 22 has a central shaft 40 which is journaled in bearing boxes 42, 44 so that the roller can be readily turned by handle 48 attached to the shaft extension 50 of roller 22.

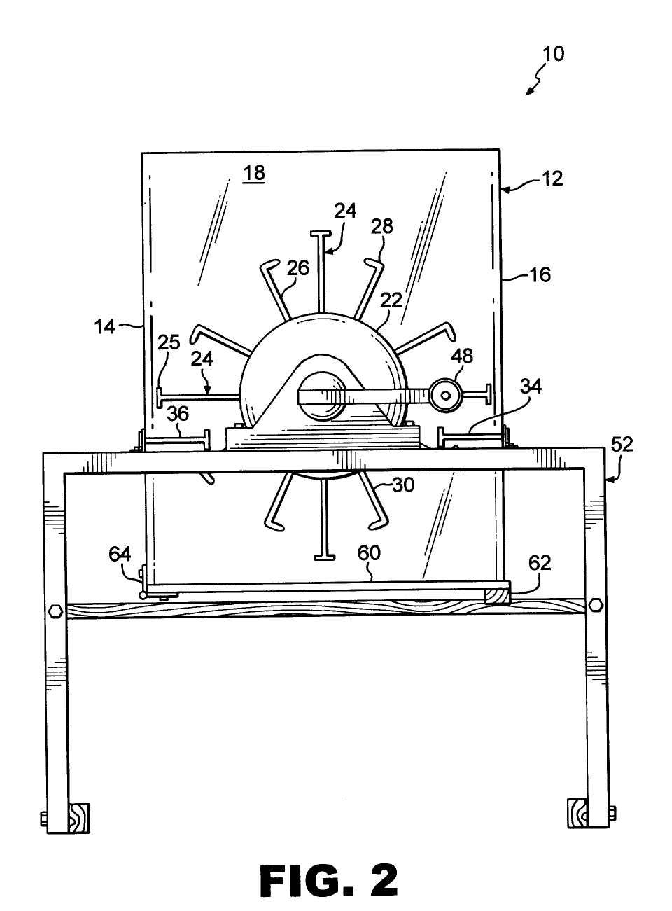

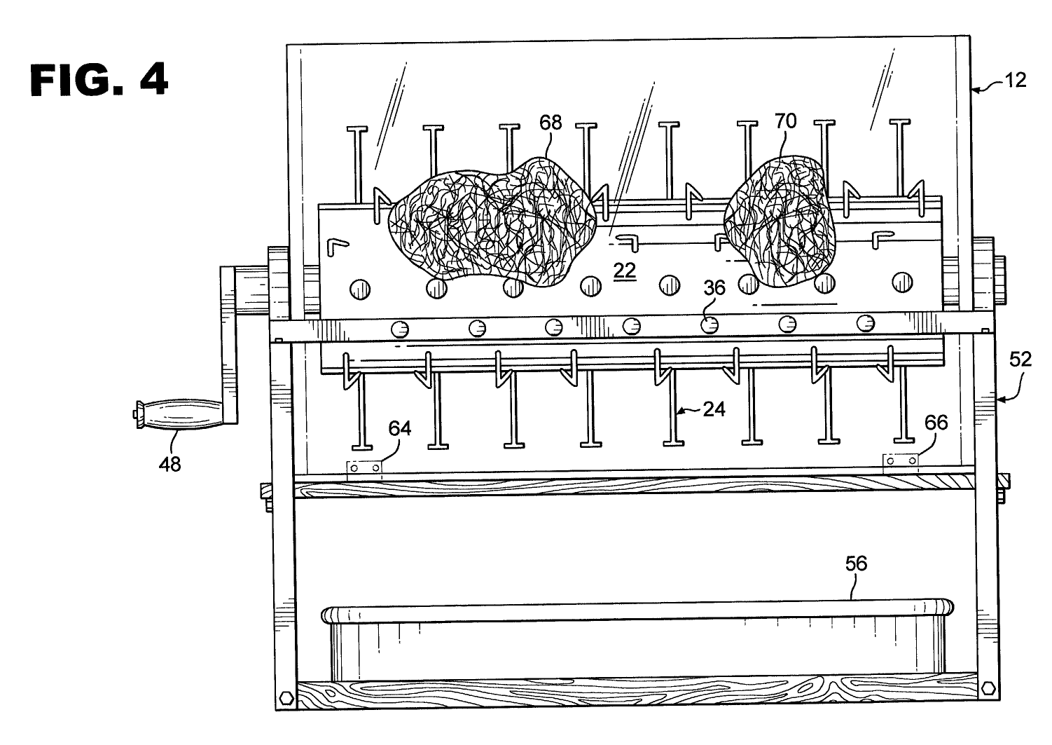

Referring to FIGS. 1, 2 and 3 housing 12 includes a bottom 60 which is pivotably mounted to a long face, e.g. face 14 as by hinges 64, 66. Bottom 60 serves as a platform to permit the cheese to be processed through the device a number of times until separation is completed. As shown in FIG. 4 when the cheese has been separated the bottom 66, temporarily held horizontal by devices such as blocks, one of which is shown as 62 in FIG. 2 can be removed and the bottom 60 pivoted or dropped open to discharge the separated or shredded cheese.

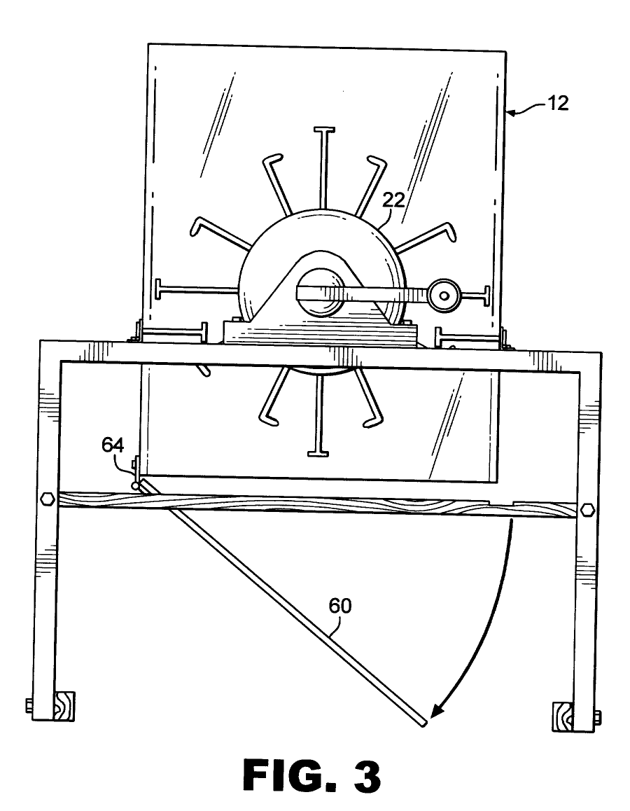

As shown in FIG. 2 and FIG. 3 the housing 12 can be placed on an open stand 52 the stand 52 being a generally rectangular frame which, as shown in FIG. 3 and FIG. 4, is adapted to have a user position a receptacle such as a tray 56 (FIG. 4) underneath the roller 22 to receive the separated cheese. The stand 50 can be made of any suitable material that is compatible for use in food handling and is preferably open to provide access and cleaning and need only be of such dimensions to support the housing 12 above the receptacle 56.

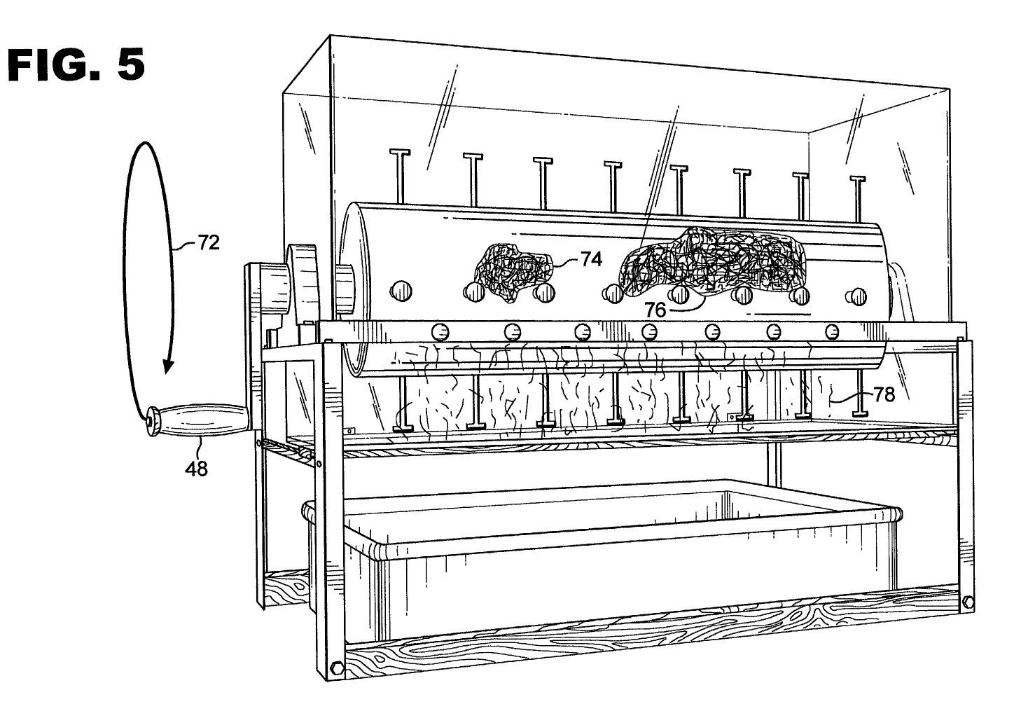

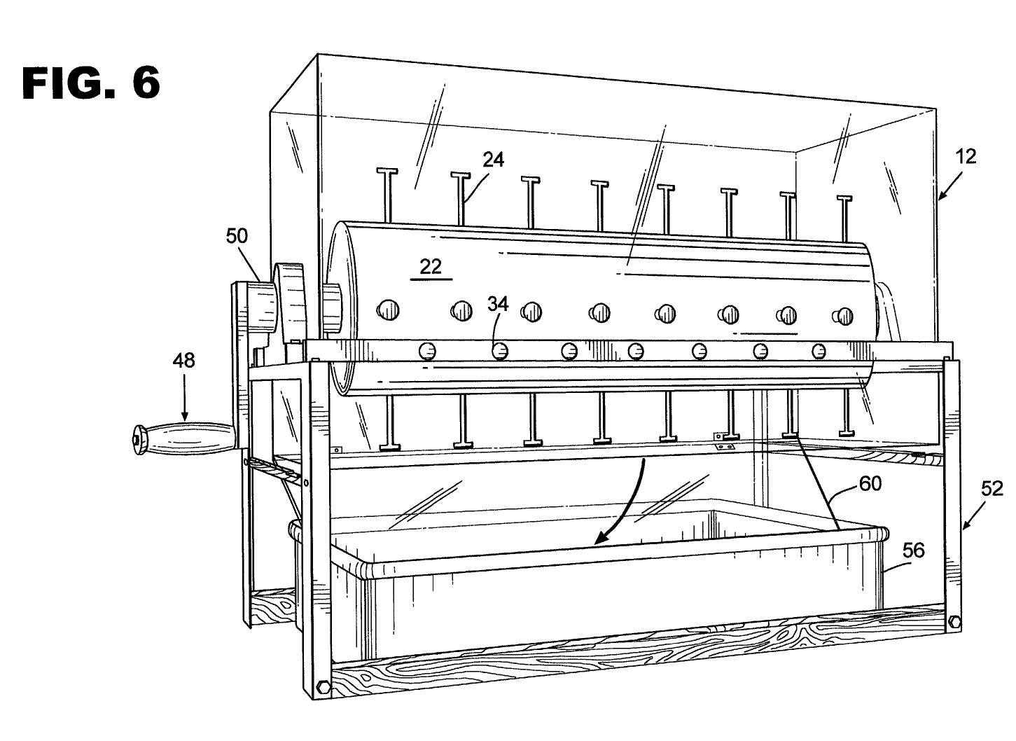

Referring to FIGS. 4, 5 and 6 clumps of cheese 68, 70 (FIG. 4) are placed in the housing 12 with bottom 60 fixed in a horizontal position thus defining a closed housing. The clumps of cheese 68, 70 are conveniently supported in the housing 12 by the tines 24, 26, 28, 30. When the handle 48 is turned in a direction such as shown by arrow 72 in FIG. 5, the clumps of cheese 68, 70 and other clumps 74, 76 (FIG. 5) are carried toward the stationary tines 34, 36 and the action of the meshing of the tines 24, 26, 28 and 30 fixed to roller 22 and stationary tines 34, 36 causes the cheese to re-separate into the original shredded pieces shown schematically as 78 in FIG. 5. As shown in FIG. 6 when the cheese has been reshredded bottom 60 can be pivoted or released from it locked horizontal position to permit the user to collect the reshredded cheese in bin or receptacle 56.

Handle 48 is adapted to turn either clockwise or counter clockwise as the user is facing the side 20 of the housing 12 and by this action the cheese clumps 68, 70, 74 and 76 can be alternately brought by movable tines on roller 22 between fixed tines on either side of the housing 12 of device 10.

A device according to the invention was constructed with the housing having width of 7¼ inches with a roller having a diameter of 3 inches. Two rows of 2½ inch fixed or stationary tines were placed on either side of the housing 12. The tines 24 on roller 22 were 2¼ inches long with shorter tines being 2 inches or 1¼ inches long measured from the surface of roller 22.

The device 10 so constructed was tested by feeding clumps of matted cheese into the housing 12 and churned by rotation of the handle 48 where the cheese was broken into smaller pieces resembling its original condition after initial shredding making the cheese useable again.

A device according to the invention is important to the owner of a shop serving pizza since the shredded cheese or the unshredded is very expensive and the most vital ingredient to making pizza. Therefore, portion control in applying cheese to the pizza is of utmost importance, not only for making excellent pizza but making excellent pizza at a competitive price.

Having thus described my invention, what is desired to be secured by letters patent of the United States as set forth in the appended claims.

What is claimed:

1. A device for separating shredded cheese that has been matted together, i.e., by temperature, pressure, settling from being in stacked containers, comprising in combination:
a housing having the shape of a rectangular prism, said housing having four sides with an open top and a bottom shelf said bottom shelf adapted to be one of opened or pivoted away from one side of said housing, said shelf adapted to permit recirculation of said cheese and to permit removal of separated cheese;
a generally cylindrical roller mound in said housing for rotation about an axis located proximate said open bottom of said housing, said axis extending between opposite smaller faces of said prism;
a plurality of tines embedded in and perpendicular to an outer surface of said roller, said tines arrayed in at least four rows, each of said rows parallel to and spaced apart from an adjacent row, each row extending along a substantial length of said outer surface of said roller, said tines in a row of tines spaced from each other; and
a plurality of fixed position tines mounted in two opposing rows on opposite larger faces of said housing adjacent said open bottom of said housing, said fixed position tines of a number and spacing to mesh with close tolerance spacing with said tines mounted on said cylinder as said cylinder is rotated.

2. A device according to claim 1 including a removable cover on said open top of said housing.

3. A device according to claim 1 including a frame in the shape of an open sided prism, said frame adapted to support said housing over a removable catch receptacle.

4. A device according to claim 1 wherein said tines on said cylinder are disposed in parallel rows each row being along an arc extending from one end to a second end of said roller.

5. A device according to claim 1 wherein said tines on said cylinder are disposed diagonally in parallel rows, each row being along a line parallel to said axis of rotation of said cylinder.

6. A device according to claim 1 including a handle fixed to a central shaft of said cylinder for rotating said cylinder.

7. A device according to claim 1 including a pulley mounted to an extension of a central shaft of said cylinder whereby a motor and drive can be used to rotate said cylinder.

8. A device according to claim 1 including means to couple a central shaft of said cylinder to a motor for rotating said cylinder.

9. A device according to claim 1 wherein said tines on said cylindrical roller are of varying length with the longest of said tines having a generally elongated cylindrical body with a generally disk shaped head on an end opposite to an end fixed in said outer surface of said cylindrical roller.
